(19) United States
(12) Patent Application Publication
(10) Pub. No.: US 2009/0061788 A1
(43) Pub. Date: Mar. 5, 2009

(54) Electromagnetic signal transceiving apparatus and method using polarized component modulation

(76) Inventor: Dong-Hsing Su, Hsichih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,434

(22) Filed: Nov. 30, 2007

(30) Foreign Application Priority Data
Sep. 4, 2007 (TW) 096132971

(51) Int. Cl. H04B 1/38

(52) U.S. Cl. 455/73

(57) ABSTRACT

This present invention provides an electromagnetic signal transceiving apparatus and method using polarized component modulation. The apparatus comprises a transmitting terminal and a receiving terminal, a transmitting terminal comprises an operation interface, an electromagnetic signal generation unit, a logic operation unit, a first polarized component and a second polarized component. A receiving terminal comprises a third polarized component, a fourth polarized component, an electromagnetic receiving unit and a processing unit. This invention is an apparatus using polarized component to modulate electromagnetic signal and using corresponding polarized component to demodulate electromagnetic signal, wherein the modulated signal can prevent other devices from being triggered during transmission.

### FIELD OF THE INVENTION

This invention relates to an electromagnetic signal transceiving apparatus and method thereof, and more particularly to a technique field of using the polarized component to modulate electromagnetic signal.

### BACKGROUND OF THE INVENTION

Presently, infrared remote control is widely adopted for managing plurality of home appliances including air conditions, televisions, etc. However, the combination of encoding of infrared remote control for electromagnetic signal is limited, furthermore, different types of home appliances may adopt identical infrared frequency for transceiving signals, and hence an embarrassment of signal interference between different types of home appliances is certain to arise. For examples, the air condition may be erroneously triggered when receiving a switching channel signal dispatched from a television remote control.

To solve the above problem, some deliberates a highly directional transceiving apparatus. However, such apparatus causes inconvenience as the direction of transmitting terminal is required to be beamed at receiving terminal in order to trigger home appliances.

Yet there is an alternative method to solve the above problem, it is designed to identify each transceiving signal from different electrical apparatus via more complex and extensive encoding scheme, however, this method results in higher cost of apparatus in which the cost is proportional to the greater complexity of transceiving signals.

The present inventor herein with many years of practical experience in series of researches and developments provides electromagnetic signal transceiving apparatus and method using polarized component modulation, said apparatus and method are forming the baseline to realize, and to solve the above problems.

### SUMMARY OF THE INVENTION

Therefore, it is one of objectives of the present invention to provide an electromagnetic signal transceiving apparatus and method using polarized component modulation for solving the signal interference problem occurred in the prior art.

According to the stated purpose above, the present invention provides an electromagnetic signal transceiving apparatus using polarized component modulation. The apparatus comprises a transmitting terminal and a receiving terminal. The transmitting terminal comprises an operation interface, an electromagnetic signal generation unit, a logic operation unit, a first polarized component and a second polarized component. The receiving terminal comprises a third polarized component, a fourth polarized component, an electromagnetic receiving unit and a processing unit.

The operation interface is for receiving an input command and sending the input command to the electromagnetic signal generation unit which generates a first electromagnetic signal based on the input command. The first electromagnetic signal is input to the first polarized component and the logic operation unit by the electromagnetic signal generation unit. The first polarized component depolarizes the first received electromagnetic signal and sends this depolarized signal to the receiving terminal. The logic operation unit is for generating the second electromagnetic signal by performing a logical calculation on the first received electromagnetic signal, and this second electromagnetic signal is then sent to the second polarized component which depolarizes the second received electromagnetic signal, and this depolarized signal is then transmitted to the receiving terminal.

The receiving terminal uses the third polarized component corresponding to the first polarized component to receive the first electromagnetic signal generated by the first polarized component, by the same token, receiving terminal uses the fourth polarized component corresponding to the second polarized component to receive the electromagnetic signal generated by the second polarized component. The first electromagnetic signal and the second electromagnetic signal are transmitted to the electromagnetic receiving unit via the third polarized component and the fourth polarized component. The electromagnetic receiving unit then transmits the first electromagnetic signal and the second electromagnetic signal to the processing unit which restores the first electromagnetic signal and the second electromagnetic signal back to output instruction.

In addition, the present invention provides another electromagnetic signal transceiving apparatus using polarized component modulation comprising a transmitting terminal and a receiving terminal. The transmitting terminal comprises an operation interface, an electromagnetic signal generation unit, a logic operation unit, a fifth polarized component and a first opening. The receiving terminal comprises a sixth polarized component, a second opening, an electromagnetic signal receiving unit and a processing unit. The operation interface is for receiving an input command which is then sent to the electromagnetic signal generation unit. Afterwards, the electromagnetic signal generation unit generates the first electromagnetic signal based on the input command. The electromagnetic signal generation unit inputs the first electromagnetic signal to the fifth polarized component and to the logic operation unit respectively. The fifth polarized component is for depolarizing the first received electromagnetic signal and then sending the depolarized signal to the receiving terminal. The logic operation unit is for generating the second electromagnetic signal by performing a logical calculation on the first received electromagnetic signal, and the second electromagnetic signal is then transmitted to the receiving terminal via the first opening.

The receiving terminal uses the sixth polarized component corresponding to the fifth polarized component to receive the first electromagnetic signal generated by the fifth polarized component, by the same token, receiving terminal uses the second opening to receive the second electromagnetic signal from the first opening. The first electromagnetic signal and the second electromagnetic signal are transmitted to the electromagnetic receiving unit via the sixth polarized component and the second opening. The electromagnetic receiving unit then transmits the received first electromagnetic signal and the received second electromagnetic signal to the processing unit which restores the first electromagnetic signal and the second electromagnetic signal back to output instruction.

Furthermore, the present invention provides a method of modulating electromagnetic signal by using polarized component, this method comprises the following steps of:
i) generating a second electromagnetic signal by phase delaying a first electromagnetic signal,
ii) using a seventh polarized component for modulating the first electromagnetic signal, and transmitting the first electromagnetic and the second electromagnetic signal,
iii) receiving the first electromagnetic signal by using an eighth polarized component which is corresponding to the seventh polarized component,
iv) using a processing unit to mix the first and the second electromagnetic signal.

As described above, following are the advantages of the electromagnetic signal transceiving apparatus and method using polarized component modulation:
1. The transceiving terminal in accordance with the present invention can prevent the receiving terminal of other apparatus being triggered erroneously.
2. The transceiving terminal in accordance with the present invention can also receive the conventional electromagnetic signal form other apparatus.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The subject matter regarded as the invention is particularly pointed out and distinctly claimed in the concluding portion of the specification. The invention, both as to apparatus and method of operation, together with features and advantages thereof may best be understood by reference to the following detailed description with the accompanying drawings in which:

FIG. 1 illustrates a block diagram of the electromagnetic signal transceiving apparatus in accordance with the present invention,

FIG. 2 illustrates a structured diagram of an embodiment of the electromagnetic signal transceiving apparatus in accordance with the present invention,

FIG. 3 illustrates a block diagram of another electromagnetic signal transceiving apparatus in accordance with the present invention,

FIG. 4 illustrates a structured diagram of another embodiment of the electromagnetic signal transceiving apparatus in accordance with the present invention,

FIG. 5 illustrates a structured diagram of the bob device of one embodiment of the present invention,

FIG. 6 illustrates a structured diagram of the bob lock device of one embodiment of the present invention,

FIG. 7 illustrates a structured diagram of polarizers being orthogonal to each other of one embodiment of the present invention,

FIG. 8 illustrates a flow diagram of embodiment of a transceiving method for electromagnetic signal in accordance with the present invention, and

FIG. 9 illustrates a flow diagram of another embodiment of a transceiving method for electromagnetic signal in accordance with the present invention.

### DETAILED DESCRIPTION OF THE PREFERRED EMBODIMENT

The present invention relates to an electromagnetic signal transceiving apparatus using polarized component modulation and method thereof. While the specifications describe at least one embodiment of the invention considered best modes of practicing the invention, it should be understood that the invention can be implemented in many ways and is not limited to the particular examples described below or to the particular manner in which any features of such examples are implemented.

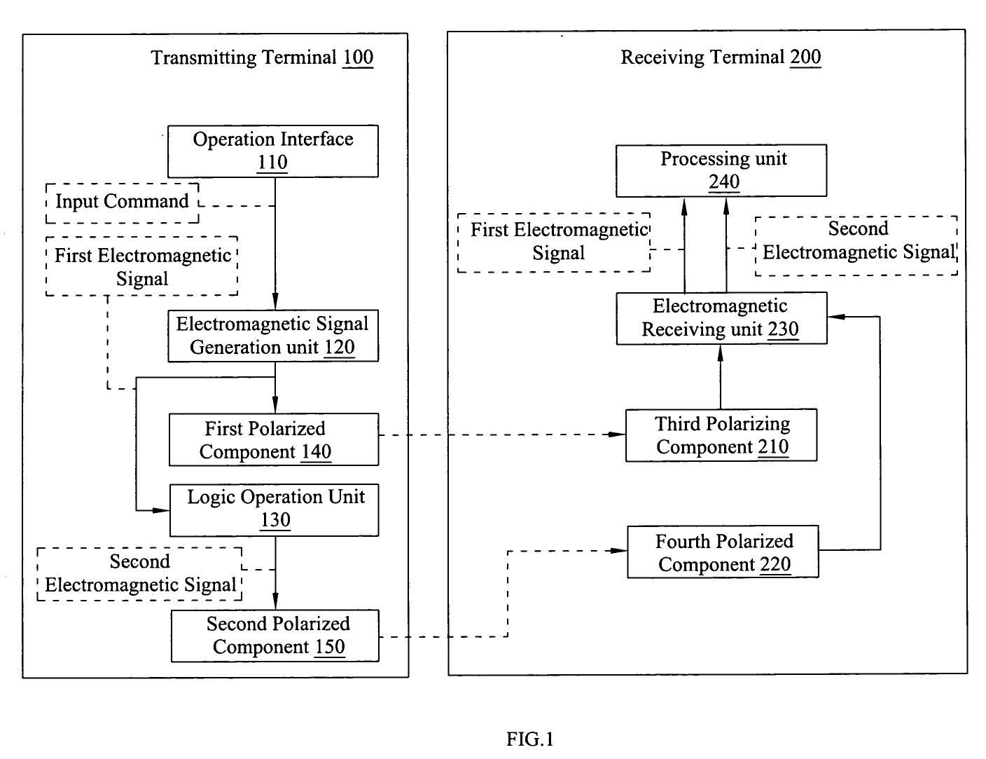

Please referring to FIG. 1 for a function block diagram of the electromagnetic signal transceiving apparatus using polarized component modulation in accordance with the present invention, the transmitting terminal 100 comprises an operation interface 110, an electromagnetic signal generation unit 120, a logic operation unit 130, a first polarized component 140 and a second polarized component 150. While the receiving terminal 200 comprises a third polarized component 210, a fourth polarized component 220, an electromagnetic receiving unit 230 and a processing unit 240.

Firstly, the operation interface 110 receives an input command and then sends this input command to the electromagnetic signal generation unit 120 which generates the first electromagnetic signal based on the input command. The generated electromagnetic unit 120 is for sending the first electromagnetic signal to the first polarized component 140 and the logic operation unit 130 respectively. The first polarized component 140 depolarizes the received first electromagnetic signal with a specific angle and sends this signal to the receiving terminal 200. The logic operation unit 130 is for generating the second electromagnetic signal by performing a logical calculation on the received first electromagnetic signal, and the second electromagnetic signal is then sent to the second polarized component 150, the second polarized component 150 depolarizes the received second electromagnetic signal with an another angle, and this depolarized signal is then transmitted to the receiving terminal 200.

The receiving terminal 200 uses the third polarized component 210 which of depolarized angular is corresponding to the first polarized component 140 to receive the first electromagnetic signal, by the same token, the receiving terminal 200 also uses the fourth polarized component 220 which of depolarized angular is corresponding to the first polarized component 150 to receive the second electromagnetic signal. The first received signal and the second received signal received by the third polarized component 210 and the fourth polarized component 220 respectively are sent to the electromagnetic receiving unit 230. The electromagnetic receiving unit 230 then sent the first electromagnetic signal and the second electromagnetic signal to processing unit 240 which is for restoring the first electromagnetic and the second electromagnetic signal back to output instruction.

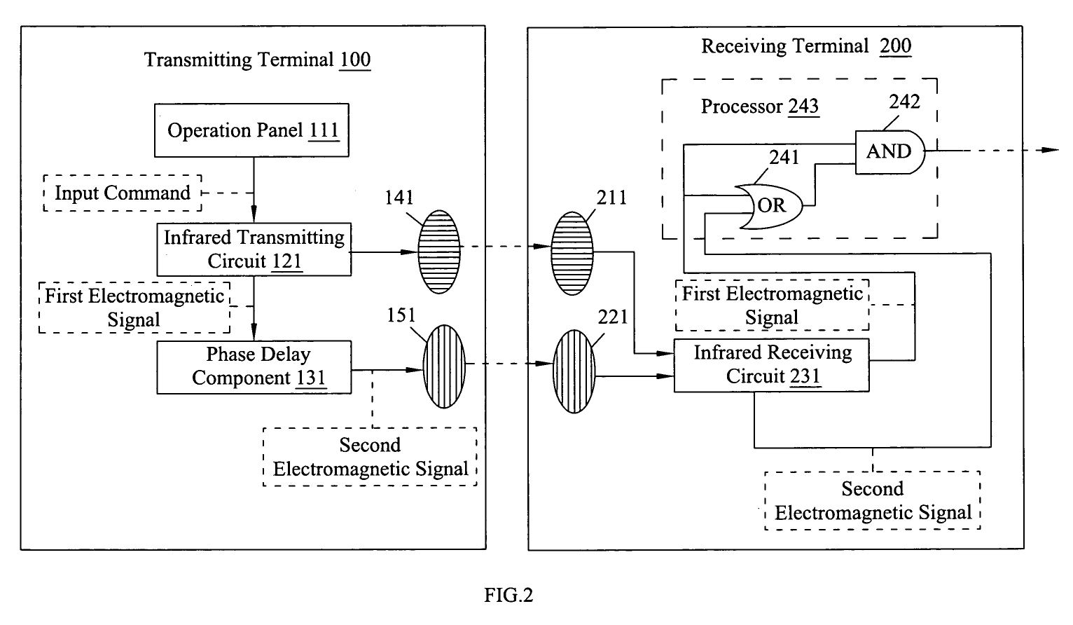

Please referring to FIG. 2 for a structure diagram of the electromagnetic signal transceiving apparatus using polarized component modulation of one embodiment of the present invention, the operation panel 111 sends the received input command to the infrared transmitting circuit 121, the infrared transmitting circuit 121 generates the first electromagnetic signal which contains the record of a series of Boolean Code generated from encoding scheme and input command, phased delay component 131 applies 180 degree phase delay to the Boolean Code within the first electromagnetic signal in order to generate the second electromagnetic signal. The purpose of said delay in the transmitting terminal 100 of this embodiment meant to distinguish the generated electromagnetic signals from previously proposed electromagnetic signals. In other words, the received signal on the receiving terminal, is the result of mixture of two sets of concrete electromagnetic signals with different phases, so the receiving terminal of prior art treats this mixed signal as a meaningless signal. Therefore, the electromagnetic signal from the transmitting terminal 100 of this embodiment can prevent other apparatus being erroneously triggered while the prior art does.

Subsequently, the following section explain how the receiving terminal 200 addresses the method for identifying the phase difference of two sets of electromagnetic signals, and restores the electromagnetic signal back to input command. Firstly, the depolarized and modulated effect is generated when the first electromagnetic signal passes through polarizer 141, in another word, none but infrared carrier with particular angle of the first electromagnetic signal can pass through. By the same token, the depolarized and modulated effect is generated when the second electromagnetic signal also passes through the second polarizer 151, in which the angle of second polarizer 151 is orthogonal to the first polarizer 141. As described above, such way is meant to orthogonally depolarize the first electromagnetic signal and the second electromagnetic signal, hence no components of a vector can exist at same angular level among two signals.

Additionally, in this embodiment, the receiving terminal 200 adopts different design structure from the prior art, it is capable to identify two electromagnetic signals existing with phase difference. The receiving terminal 200 receives the first electromagnetic signal by using the third polarized component 211 of which depolarized angular is corresponding to the first polarized component 141, by the same token, the receiving terminal 200 also receives the second electromagnetic signal by using the fourth polarized component 221 of which depolarized angular is corresponding to the first polarized component 151. The electromagnetic signal must have the same vector of depolarized angle of the polarizer in order to pass through the polarizer exclusively, in other words, the polarizer is impenetrable if the depolarized angle of electromagnetic signal is orthogonally towards to the polarized angle of the polarizer. Herein, in this embodiment, the receiving terminal 200 can identify the first electromagnetic signal and the second electromagnetic signal, and use the infrared receiving circuit 231 to receive the first electromagnetic signal and the second electromagnetic signal respectively. Wherein the first electromagnetic signal is mixed from the first depolarized electromagnetic signal and the second depolarized electromagnetic signal, this is to ensure the accuracy of Boolean Code which is not influenced by the polarized modulation carried on the first electromagnetic signal.

In this embodiment, the processor 243 uses the logic OR gate 241 to mix the first depolarized electromagnetic signal and the second depolarized electromagnetic signal for generating a confirming signal, and then uses the logic AND gate 242 to mix the confirming signal and the second electromagnetic signal. Certainly, as described above, same result can be achieved by mixing the confirming signal and the first electromagnetic signal in another embodiment of the present invention, hence the present invention is not limited to this.

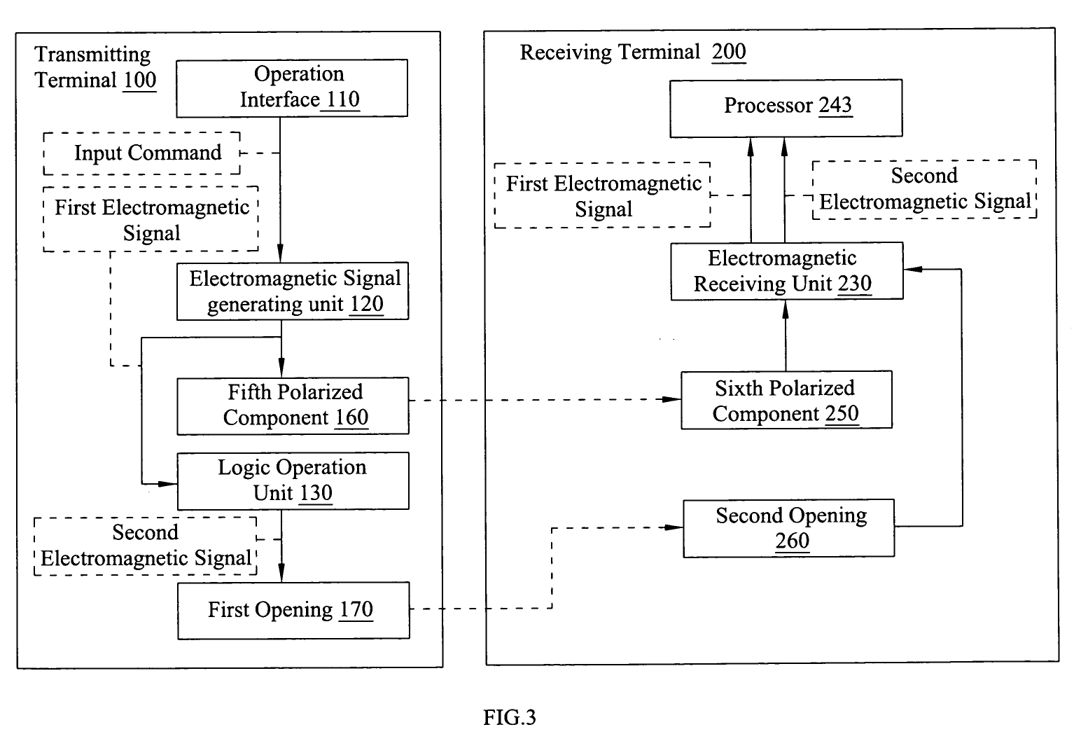

Please referring to FIG. 3 for a lock diagram of another electromagnetic signal transceiving apparatus in accordance with the present invention, the transmitting terminal 100 comprises an operation interface 110, an electromagnetic signal generation unit 120, a logic operation unit 130, a fifth polarized component 160 and a first opening 170, and the receiving terminal 200 comprises a sixth polarized component 250, a second opening 260, an electromagnetic receiving unit 230 and a processing unit 240.

Firstly, the operation interface 110 is for receiving an input command and sending this input command to the electromagnetic signal generation unit 120 which then generates the first electromagnetic signal based on the input command and sends the first electromagnetic signal to the fifth polarized component 160 and logic operation unit 130 respectively. The fifth polarized component 160 depolarizes the first received electromagnetic signal with an angular and sends the depolarized electromagnetic signal to the receiving terminal 200. The logic operation unit 130 is for generating the second electromagnetic signal by performing a logic calculating on the first received electromagnetic signal, and the second electromagnetic signal is then transmitted to the receiving terminal 200 via the first opening 170.

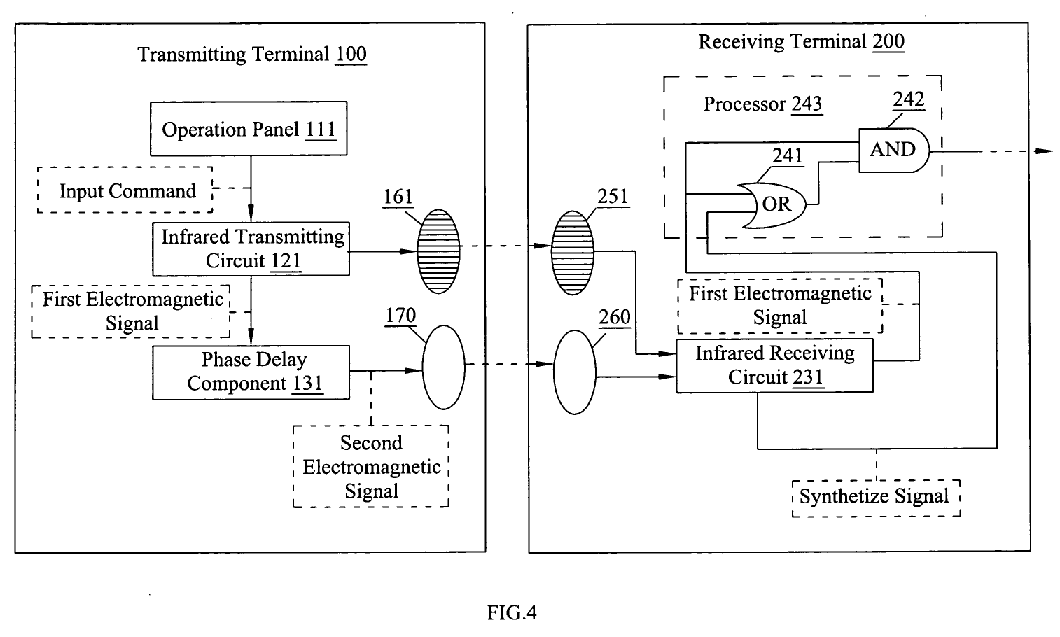

The receiving terminal 200 receives the first electromagnetic which is from the fifth polarized component 160 by using the sixth polarized component 250 corresponding to the fifth polarized component 160, at the same time, the receiving terminal 200 receives the second electromagnetic signal via the second opening 260. The sixth polarized component 250 and the second opening 260 then send the first received electromagnetic signal and the second received electromagnetic signal to the electromagnetic receiving terminal 230 respectively. The first electromagnetic signal and the second electromagnetic signal received by the electromagnetic receiving terminal 230 are sent to the processing unit 240 which then restores the first electromagnetic signal and the second electromagnetic signal back to output instruction. Please referring to FIG. 4 for a structure diagram of another embodiment of the electromagnetic signal transceiving apparatus using polarized component modulation in accordance with the present invention, the working principle of this embodiment is identical to the embodiments described above, herein is the illustration with distinctive features from embodiments mentioned above. The embodiment shown in FIG. 4 is characterized by using the fifth polarizer 161 and the sixth polarizer 251 to depolarize the first electromagnetic signal.

Thus, with regarding to the receiving terminal of the prior art, the receiving terminal still receives the first polarized electromagnetic signal, and the second un-depolarized but phase delayed electromagnetic signal, hence the receiving terminal of the prior art will treat this receiving signal as cumulative and meaningless. As for the receiving terminal 200 in this embodiment, the sixth polarizer 251 receives the first depolarized electromagnetic signal, and the component of the second electromagnetic signal in polarize angular of the sixth polarizer 251. Because the non-depolarized second electromagnetic signal is degraded by media during transmission, hence the signal passing through the sixth polarizer 251 can be disregarded as a noise. Therefore, the signal passing through the sixth polarizer 261 and the infrared receiving circuit 231 can be concluded as the first electromagnetic signal, wherein the carried Boolean Code is thus identifiable. While the cumulative signal of first electromagnetic and the second electromagnetic signal is received via the second opening 260, and the cumulative signal is then mixed with the first electromagnetic signal to generate the confirmation signal which is the basis for ensuring the first electromagnetic signal.

As described above, another advantage of this embodiment is that the receiving terminal 200 can also receive the sending signal from the transmitting terminal of prior art if user loses the transmitting terminal 100. The working principle of the sending signal in one embodiment is as below. The infrared receiving circuit 231 receives two sets of identical electromagnetic signals and mixes these signals by processor 243, thus the Boolean Code carried on electromagnetic signals remains the same.

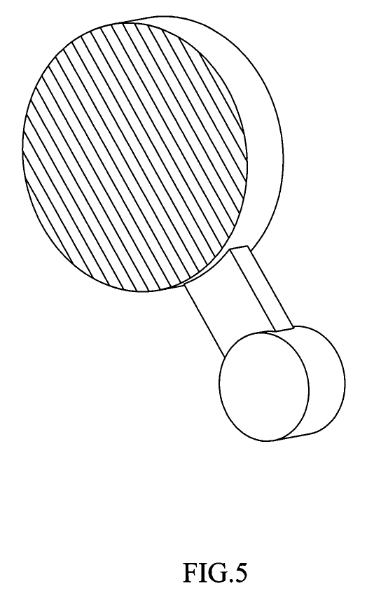

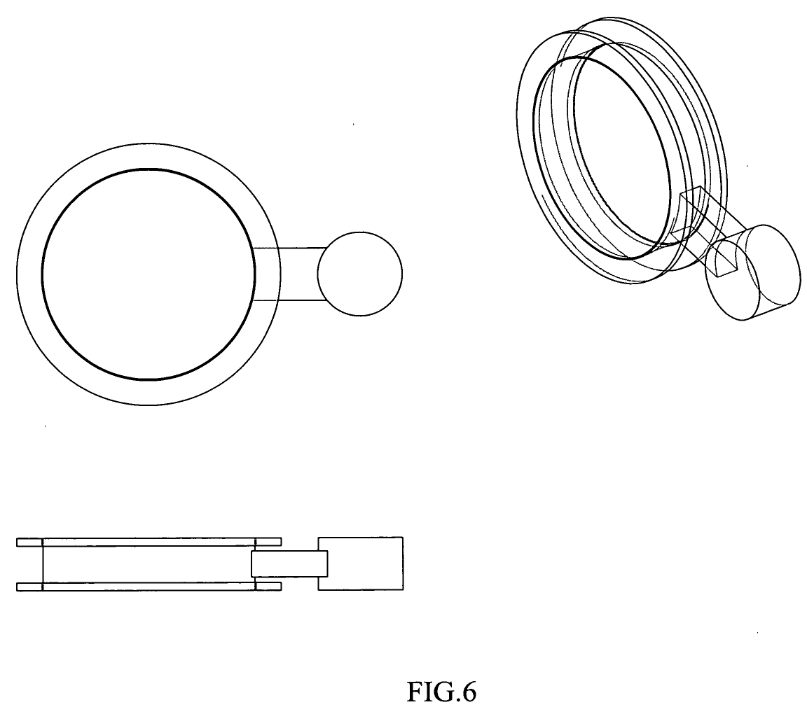

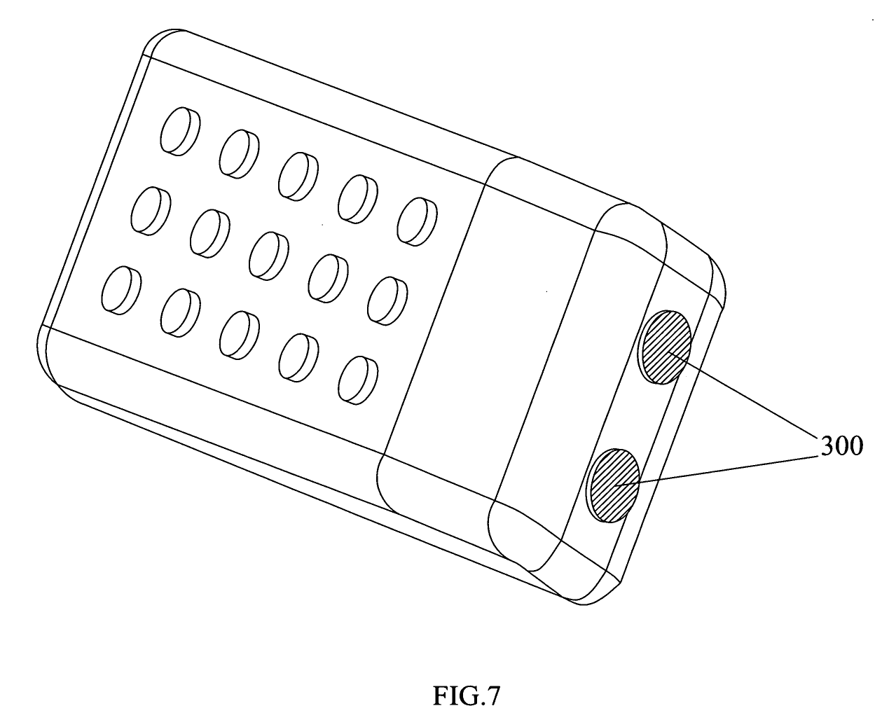

In order to realize the orthogonal design of the first polarizer 141 and the second polarizer 151 as shown in FIG. 2 in above embodiments. The present invention provides a counterpoise structure as shown in FIG. 5 and FIG. 6, this is designed to enable the first polarizer 141 and the second polarizer 151 maintaining an fixed angle with the horizontal respectively, so that depolarized angle of the third polarizer 211 and the fourth polarizer 221 can correspond to the depolarized angle of the first polarizer 141 and the second polarizer 151. FIG. 5 illustrates a structured diagram of the bob device in one embodiment. This is designed for polarizer to maintain a fixed horizontal angel. FIG. 6 is the structured diagram of the bob lock device in one embodiment, which is connected with transmitting terminal 100 and is meant to carry the bob device as described above. FIG. 7 is a structured diagram of the bob device structure in one embodiment, herein a set of corresponding polarizer is orthogonal to each other, herein the polarizer is maintained at a fixed horizontal angel via said bob device structure.

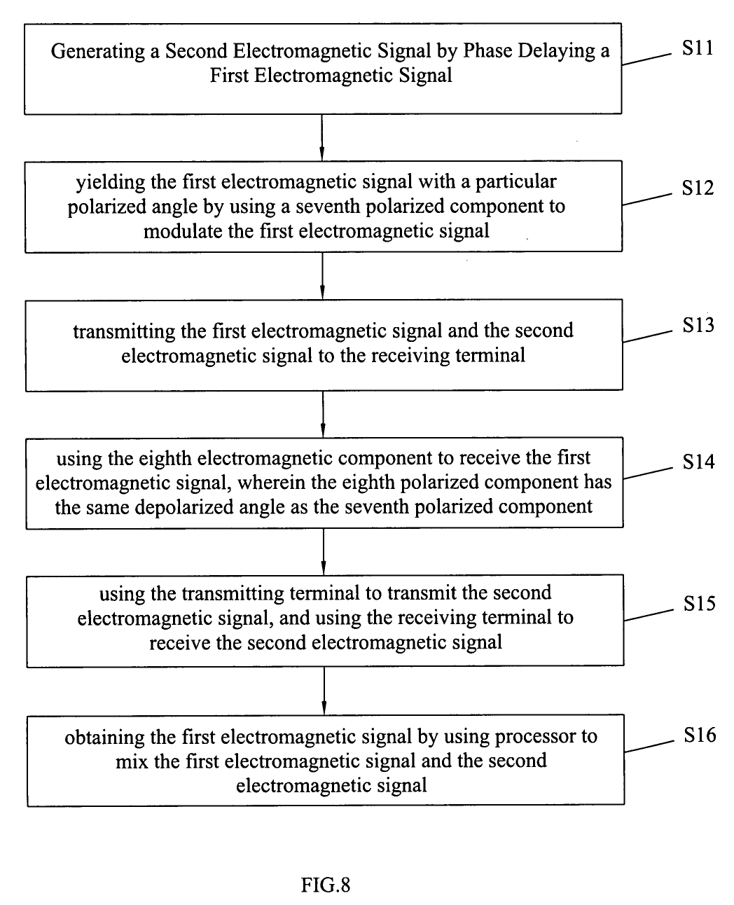

Please referring to FIG. 8 for a flow diagram of an embodiment of the electromagnetic signal transceiving method using polarized component modulation in accordance with the present invention, this method includes the following steps of:

step S11: generating a second electromagnetic signal by phase delaying a first electromagnetic signal.

step S12: yielding the first electromagnetic signal with a particular polarized angle by using a seventh polarized component to modulate the first electromagnetic signal.

step S13: transmitting the first electromagnetic signal and the second electromagnetic signal to the receiving terminal.

step S14: using the eighth electromagnetic component to receive the first electromagnetic signal, wherein the eighth polarized component has the same depolarized angle as the seventh polarized component.

step S15: using the transmitting terminal to transmit the second electromagnetic signal, and using the receiving terminal to receive the second electromagnetic signal.

step S16: obtaining the first electromagnetic signal by using processor to mix the first electromagnetic signal and the second electromagnetic signal.

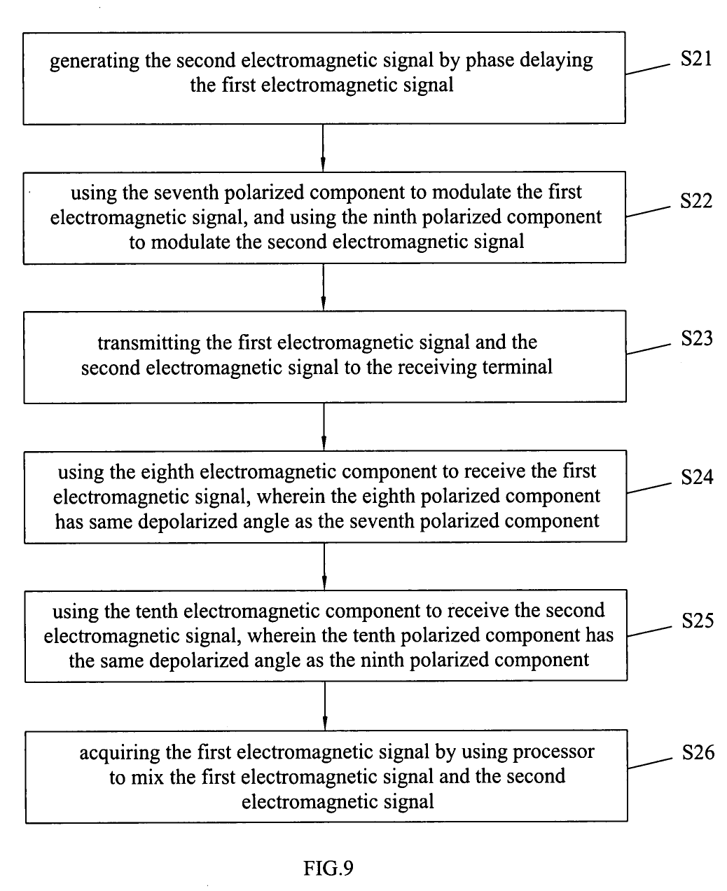

Please referring to FIG. 9 for a flow diagram of another embodiment of another electromagnetic signal transceiving method using polarized component modulation in accordance with the present invention, this method including the following steps of:

step S21: generating the second electromagnetic signal by phase delaying the first electromagnetic signal.

step S22: using the seventh polarized component to modulate and angularly depolarize the first electromagnetic signal, then using the ninth polarized component to modulate and angularly depolarize the second electromagnetic signal.

step S23: transmitting the first electromagnetic signal and the second electromagnetic signal to the receiving terminal.

step S24: using the eighth electromagnetic component to receive the first electromagnetic signal, wherein the eighth polarized component has same depolarized angle as the seventh polarized component.

step S25: using the tenth electromagnetic component to receive the second electromagnetic signal, wherein the tenth polarized component has the same depolarized angle as the ninth polarized component.

step S26: acquiring the first electromagnetic signal by using processor to mix the first electromagnetic signal and the second electromagnetic signal.

While the present invention has been described in particular embodiments, it should be appreciated that the present invention should not be construed as limited by such embodiments set forth herein; on the contrary, the present invention is intended to cover alternatives, modifications, and equivalents which may be included within the spirit and scope of the present invention as defined by the appended claims.

What is claimed is:

1. An electromagnetic signal transceiving apparatus using polarized component modulation, comprising:
a transmitting terminal comprising:
an operation interface, for entering an input command;
an electromagnetic signal generation unit, for generating a first electromagnetic signal based on said input command;
a logic operation unit, for performing a logical calculation on received electromagnetic signal to generate a second electromagnetic signal;
a first polarized component, wherein said first electromagnetic signal is transmitting through said first polarized component to far terminal;
a second polarized component, wherein said second electromagnetic signal is transmitting through said first polarized component to far terminal; and
a receiving terminal, installed in an electrical device and comprising:
a third polarized component, corresponding to said first polarized component;
a fourth polarized component, corresponding to said second polarized component;
an electromagnetic receiving unit, for receiving said first electromagnetic signal and said second electromagnetic signal, through said third polarized component and said fourth polarized component respectively;
a processing unit, for receiving said input command based on said first electromagnetic signal and said second electromagnetic signal.

2. The apparatus of claim 1, wherein said first polarized component, said second polarized, said third polarized component and said fourth component are the polarizer respectively.

3. The apparatus of claim 2, wherein the polarized angle of said second polarized component and said fourth polarized component, is orthogonal to said first polarized component and said third polarized component.

4. The apparatus of claim 2, wherein said polarizer further comprises a bob device.

5. The apparatus of claim 1, wherein said electromagnetic signal generation unit is an infrared transmitting circuit.

6. The apparatus of claim 1, wherein said electromagnetic receiving unit is an infrared receiving circuit.

7. The apparatus of claim 1, wherein said logic operation unit comprises a phase delay component.

8. An electromagnetic signal transceiving apparatus using polarized component modulation, wherein the apparatus comprising:
a transmitting terminal comprising:
an operation interface, for inputting command entering;
an electromagnetic signal generation unit, for generating a first electromagnetic signal based on said input command;
a logic operation unit, for generating a second electromagnetic signal by performing the calculation on received electromagnetic signal;
a first polarized component, for transmitting said first electromagnetic signal to far terminal;
a first opening, wherein said second electromagnetic signal is transmitted through said first opening; and
a receiving terminal placed in an electrical device, comprising:
a second polarized component, corresponding to said first polarized component;
a second opening, corresponding to said first opening;
an electromagnetic receiving unit, receiving said first electromagnetic signal and said second electromagnetic signal through said second polarized component and said second opening respectively;
a processing unit, receiving said input command based on said first electromagnetic signal and said second electromagnetic signal.

9. A electromagnetic signal transceiving method using polarized component modulation, said method comprising:
generating a second electromagnetic signal by phase delaying a first electromagnetic signal;
using a first polarized component to modulate said first electromagnetic signal;
transmitting said first electromagnetic signal and second electromagnetic signal;
using the second polarized component corresponding to the first polarized component to receive said first electromagnetic signal;
receiving said second electromagnetic signal; and
using a processing unit synthesize said first electromagnetic signal and said second electromagnetic signal.

10. The method of claim 9, further comprising a step of using a third polarized component to modulate said second electromagnetic signal, and using a fourth polarized component corresponding to said third polarized component to receive said second electromagnetic signal.
